(19) United States
(12) Patent Application Publication
(10) Pub. No.: US 2025/0274046 A1
(43) Pub. Date: Aug. 28, 2025

(54) CONVERTER WITH ZERO CURRENT DETECTION, CORRESPONDING DEVICE AND METHOD

(71) Applicant: STMicroelectronics International N.V., Geneva (CH)

(72) Inventors: Salvatore TRICOMI, San Gregorio di Catania (IT); Simone SCADUTO, Mussomeli (IT); Agatino Antonino ALESSANDRO, Rho (MI) (IT); Daniele CASELLA, Francofonte (IT)

(73) Assignee: STMicroelectronics International N.V., Geneva (CH)

(21) Appl. No.: 19/050,593

(22) Filed: Feb. 11, 2025

(30) Foreign Application Priority Data
Feb. 26, 2024 (IT) 102024000003991

(51) Int. Cl. H02M 3/158; H02M 1/00

(52) U.S. Cl. CPC H02M 3/158; H02M 1/0009

(57) ABSTRACT

A buck, boost or inverted topology converter includes high-side and low-side power stages with a coil coupled therebetween at a current supply node. A zero-crossing detection (ZCD) circuit includes a comparator that generates a detection signal when coil current has a zero crossing event. Threshold tuning circuitry selectively varies a threshold of the comparator in a first direction or in a second direction, based on a feedback signal provided by voltage detection circuitry coupled to a voltage detection node at the coil. The presence or absence of a voltage transition at the voltage detection node is indicative of the detection signal being issued in advance of or with delay with respect to a zero-crossing event of the coil current.

### PRIORITY CLAIM

This application claims the priority benefit of Italian Application for Patent No. 102024000003991, filed on Feb. 26, 2024, the content of which is hereby incorporated by reference in its entirety to the maximum extent allowable by law.

### TECHNICAL FIELD

The description relates to converters including zero current detector (ZCD) circuits.

Aspects of the present description are applicable, for instance, to DC-DC converters including a ZCD comparator.

Aspects of the present description can be used in notionally all kinds of applications using a DC-DC converter.

### BACKGROUND

Detecting a zero current condition of a current flowing through a coil (a coil current) is a feature of DC-DC converters that facilitates managing transitions from a continuous mode of operation (referred to as continuous current mode—CCM) to a discontinuous mode operation (referred to as discontinuous current mode—DCM).

A zero current detector (ZCD) is a circuit block configured to detect a zero current condition in a coil in a converter. Such a converter usually includes a low side (LS) switch and a high side (HS) switch.

A ZCD cell can be designed in different ways, depending on the DC-DC converter topology and the shape (waveform) of the coil current.

A conventional solution for implementing a ZCD cell involves monitoring operation of the half-bridge power section of the converter.

The phase of the coil current (positive/negative slope) used to determine the condition for zero detection is a factor that deserves to be taken into account for that purpose.

For instance, current detection may take place during the T_{OFF} phase (negative slope) with the current-sensing element implemented using a “R_{ON}” power switch that is “on” (that is, conductive) during the selected phase. Detection involves monitoring a voltage drop across the sensing element.

FIG. 1 is exemplary of such a solution used in a “buck” converter where zero-crossing detection (ZCD) involves monitoring a voltage at a node SW intermediate the high-side power stage HS Power (which includes a HS switching transistor) and the low-side power stage LS Power (which includes a LS switching transistor) of a converter, with the low-side power stage LS Power arranged between the node SW and ground GND.

The node SW is coupled to a coil L in the converter with the coil L traversed by a current Icoil.

The ZCD cell 10 compares the voltage at the node SW with a reference to produce an output signal ZCD_OUT that can be gated at an AND gate via a gating signal Gate_LS to produce a gated ZCD signal ZCD_OUT_MASK.

As illustrated in the diagram of FIG. 1A: when the transistor of the low-side power stage LS Power is “on” (conductive—LS ON), Icoil>0, VSW<GND, and the ZCD cell output is low; and when LS ON, Icoil<0, VSW>GND, and the ZCD output is high.

FIG. 2 is illustrative of the case of a “boost” converter where zero current detection, ZCD involves monitoring a voltage (VOUT—SW) across the transistor of the high-side power stage HS Power of the converter. In FIG. 2, the same reference symbols of FIG. 1 have been used for brevity.

As illustrated in the diagrams of FIG. 2A, in the case of the arrangement of FIG. 2: when the transistor of the high-side power stage HS Power is in “on” (conductive—HS ON), Icoil>0, VSW>VOUT, and the ZCD output is low; and when HS ON, Icoil<0,VSW<VOUT, and the ZCD output is high.

FIG. 3 is illustrative of the case of an (inverted) “buck-boost” where ZCD detection involves monitoring a voltage (VOUT—SW) across the transistor of the low-side power stage LS Power of the converter. In FIG. 3, the same reference symbols of FIG. 1 and FIG. 2 have been used for brevity.

As illustrated in the diagrams of FIG. 3A, in the case of the arrangement of FIG. 3: when the transistor of the low-side power stage LS Power is “on” (conductive—LS ON), Icoil>0, VSW<VOUT, and the ZCD output is low; and when LS ON, Icoil<0, VSW>VOUT, and the ZCD output is high.

FIG. 1, FIG. 2 and FIG. 3 are all exemplary of converters comprising: a high-side power stage HS Power and a low-side power stage LS Power having a coil L coupled therebetween at a current supply node, wherein the coil is configured to be traversed by a coil current Icoil in response to the transistor of the high-side power stage HS Power and the transistor of the low-side power stage LS Power being turned on and off (not necessarily in an alternate manner; and a zero-crossing detection (ZCD) circuit 10 configured to detect zero crossing events of the coil current Icoil wherein the ZCD circuit 10 comprises a—voltage-detection node SW configured to be coupled to the coil L at the—current-supply node.

FIG. 4 illustrates, in the exemplary case of a buck configuration and against a common (abscissa) time scale t, possible time behaviors of—from top to bottom: the current Icoil, the voltage at the sensing node SW between the high-side and the low-side power transistor stages, and the ZCD detection signal ZCD_OUT.

It is noted that the following discussion related to FIG. 4 applies, mutatis mutandis, to all of the topologies illustrated in FIG. 1, FIG. 2 and FIG. 3. Also, the value Min 250 nS is of course purely exemplary and non-limiting.

Zero-crossing detection efficiency is facilitated by having a (very) fast zero-crossing comparator: in fact, any long latency time of the comparator results in a system reaction likely to occur when the current through the coil L is already inverted.

The effective total delay is composed by comparator delay, that is dependent on the supply voltage, and the slope of the signal at the SW node, that is a function of the voltage V_{OUT} and the inductance value of the (external) coil L.

The diagram of FIG. 5A develops on the diagram of FIG. 4 by showing that comparator latency and offset (essentially, the intervention threshold of the comparator) may give rise to a first problem.

FIG. 5A highlights that, in the absence of a fast comparator response, the coil current Icoil may be stopped (turned off) in response to a ZCD detection signal delayed of a time t_{Delay} when the current Icoil is already inverted.

Latency should be desirably compatible with a maximum switching frequency. A (very) low offset and a fast reaction time (low latency) are hardly compatible unless quite complex circuit arrangements are resorted to.

The diagram of FIG. 5B shows that Vout voltage and coil current coverage may give rise to a second problem.

In fact, the slope of the coil current during the Toff phase (possible time behaviors Icoil1, Icoil2, Icoil3 with different slopes are shown by way of example in FIG. 5B) depends on both the (regulated) output voltage and the impedance of the coil L (indicated simply as “coil”), that is the very type of coil used, in accordance with:

$$dI / dT = {V}_{O U T} / Coil$$

Design of ZCD comparators can take into account the maximum coil current slope allowed as a design parameter in order to reduce the detection error. This may result in a sort of over-design optimized for a single application case.

The diagram of FIG. 5C shows that temperature and corner compensation may give rise to still further problems.

In fact, the “on” resistance Ron of sense element plus the reaction time and offset of the comparator may change as a consequence of temperature (see “Hot” and “Cold” conditions as indicated at the bottom of FIG. 5C) and corner spread.

As a result, the accuracy of the ZCD detection threshold will change according with the variation of power MOS Ron, offset and variations in T_{Delay} for the comparators.

Possible approaches in addressing these issues may involve: dynamic offset cancellation in the comparators; devising a dedicate design option for a dedicated application case; or statically trimming the ZCD threshold and T_{Delay}.

Dynamic offset cancellation has the disadvantage of being ineffective on comparator delay time and may eventually give rise to a complex implementation.

A dedicated design option for a dedicated application case fails to provide a full case coverage as desirable, and may also involve using different part numbers for different use cases.

Statically trimming a ZCD threshold can be done during a final test using a slow ramp. In functional mode it will be different if pre-trimming correlation is not taken into account.

There is a need in the art to contribute in addressing the various issues discussed in the foregoing.

### SUMMARY

One or more embodiments relate to a converter.

One or more embodiments relate to a corresponding device (any device using a DC-DC converter may be exemplary of such a device).

One or more embodiments relate to a corresponding method.

Solutions as described herein offer one or more of the following advantages: low area occupation in comparison with accurate but complex comparators; compensation of comparator latency; and flexibility versus application cases.

Solutions as described herein facilitate providing zero current detectors for various types of DC-DC converters.

Solutions as described herein can be optimized for buck converters, but are likewise applicable to boost converter and inverted (“buck-boost”) topologies: see, for instance, the topologies discussed in the introductory portion of this description.

That is, the solutions as described herein are applicable in general to zero-crossing detection circuits configured to be coupled to a coil coupled to a current supply node between a high-side power stage HS Power and a low-side power stage LS Power, wherein the coil is traversed by a coil current Icoil (negative or positive: see, for instance, FIG. 24B, as discussed in the following) in response to the transistor of the high-side power stage HS Power and the transistor of the low-side power stage LS Power being turned on and off.

Throughout this description a same designation (namely SW) will be used for simplicity for the node intended to act both as: a—current-supply node between the high-side power stage HS Power and the low-side power stage LS Power where the coil is coupled to the power stages HS Power and LS Power to be traversed by a current exhibiting zero crossing points, namely points where the current intensity has a zero value; and a—voltage-detection node of the ZCD circuit described herein, to detect voltage variations occurring at that node with the purpose of identifying (via voltage detection) zero crossing points of the current Icoil through the coil L.

Solutions as described herein involve on-the-fly correction, which facilitates using simple comparators that do not need accurate and very fast comparator performance. On-the-fly calibration (per se known in the art for other parameters) was found to lend itself to be used in a particularly advantageous manner in the case of voltage-based zero-crossing detection (ZCD).

Solutions as described herein adopt continuous “on-the-fly” calibration and can optimize a ZCD threshold (thus increasing system efficiency) primarily in respect of comparator latency.

Solutions as described herein can cover a variety of different application cases without using complex structures, also mitigating undesired production spread.

### BRIEF DESCRIPTION OF THE DRAWINGS

One or more embodiments will now be described, by way of example only, with reference to the annexed figures, wherein:

FIGS. 1-1A, 2-2A, 3-3A, 4, and 5A-5C have already been discussed in the foregoing in presenting the related art and the drawbacks experienced thereby;

FIG. 6 schematically represents a principle underlying embodiments of the present description;

FIGS. 7A and 7B, FIGS. 8A and 8B, plus FIGS. 9A and 9B further detail principles underlying embodiments of the present description;

FIGS. 10, 11, and 12 are time diagrams exemplary of signals that may occur in embodiments of the present description;

FIGS. 13 and 14 detail certain possible features of embodiments of the present description;

FIG. 15 is a circuit diagram of an embodiment of the present description;

FIG. 16 exemplifies a principle possibly underlying embodiments of the present description;

FIG. 17 is a circuit diagram of an embodiments of the present description implementing the principle exemplified in FIG. 16;

FIG. 18 exemplifies possible operation of an embodiment of the present description;

FIGS. 19 and 20 further detail possible operation of an embodiment of the present description;

FIGS. 21A, 21B, and 21C exemplify possible operation of an embodiment of the present description;

FIGS. 22A, 22B, and 23 further detail possible operation of an embodiment of the present description;

FIGS. 24A and 24B detail zero current diode detection in an embodiment of the present description;

FIGS. 25 and 26 further detail zero current diode detection in an embodiment of the present description;

FIG. 27 is a circuit diagram of an embodiment of the present description;

FIG. 28 exemplifies possible operation of the circuit of FIG. 27;

FIG. 29 is a block diagram of exemplary circuitry configured to test a self-calibration loop, with a cell hosting the calibration procedure with associated circuitry to provide a test bench which facilitates testing circuit behavior in line with FIGS. 30A, 30B, 31, and 32A, 32B;

FIGS. 30A and 30B exemplify possible operation of the circuit of FIG. 29;

FIG. 31 is a time diagram illustrative of possible advantageous features of embodiments of the present description; and

FIGS. 32A and 32B exemplify the possible effect of the features of FIG. 31.

### DETAILED DESCRIPTION

The figures are drawn to clearly illustrate the relevant aspects of the embodiments and are not necessarily drawn to scale.

The edges of features drawn in the figures do not necessarily indicate the termination of the extent of the feature.

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular configurations, structures, or characteristics may be combined in any adequate way in one or more embodiments.

The headings/references used herein are provided merely for convenience and hence do not define the extent of protection or the scope of the embodiments.

Throughout the figures annexed herein, unless the context indicates otherwise, like parts or elements are indicated with like references/numerals and a corresponding description will not be repeated for the sake of brevity.

Also, for the sake of simplicity and ease of explanation, a same designation may be applied throughout this description to designate: a certain node or line as well as a signal occurring at that node or line (the node SW referred to throughout this description is exemplary of this); and/or a certain component (such as a capacitor, resistor or inductor of coil) as well as electrical parameter thereof: the designation “coil” used both for the inductor L and its inductance (impedance) value is exemplary of this.

The abbreviation ZCD will be used throughout this description when referring to zero-crossing detection or a detector configured to detect a zero-crossing condition where the intensity of a current flowing through an inductor reaches (and crosses) a zero value.

As discussed in the introductory portion of this description, a zero-crossing detection comparator should be desirably able to monitor a voltage at a coil (such as the voltage at the node SW discussed previously) and, based thereon, identify the condition in which the current flowing in the coil is zero.

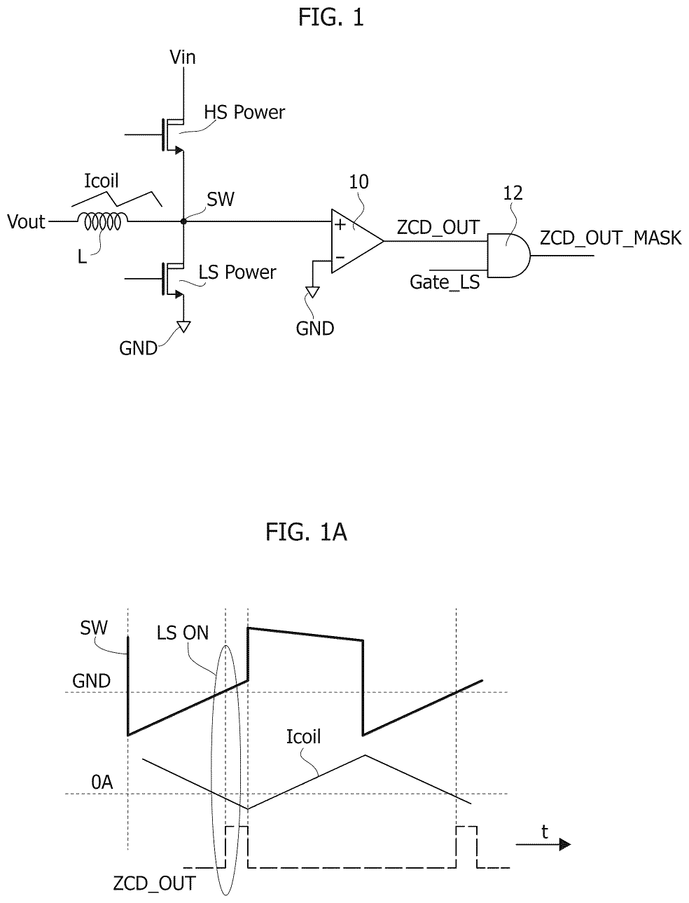

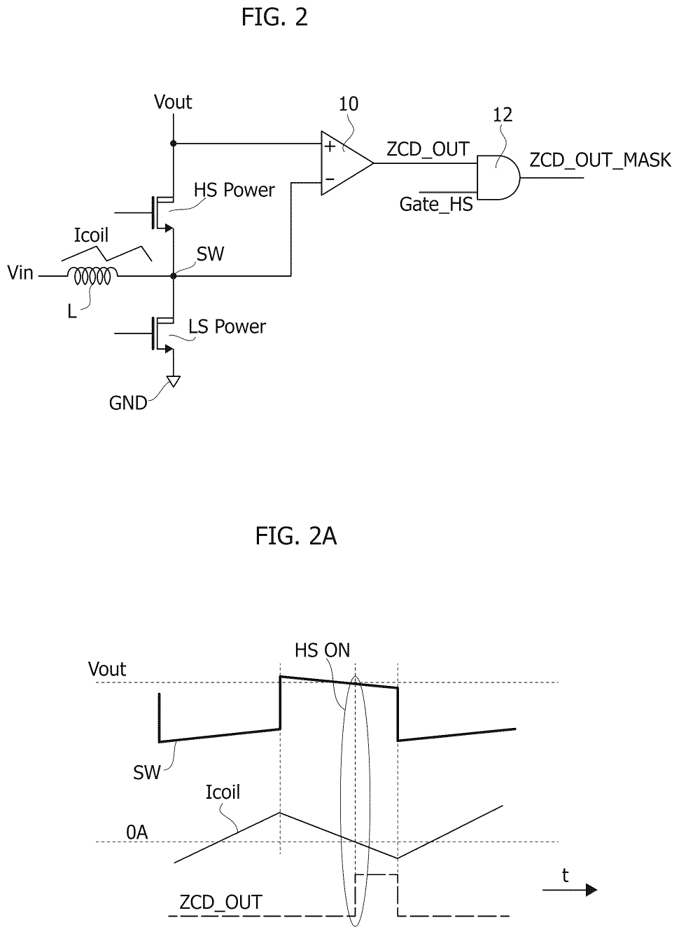

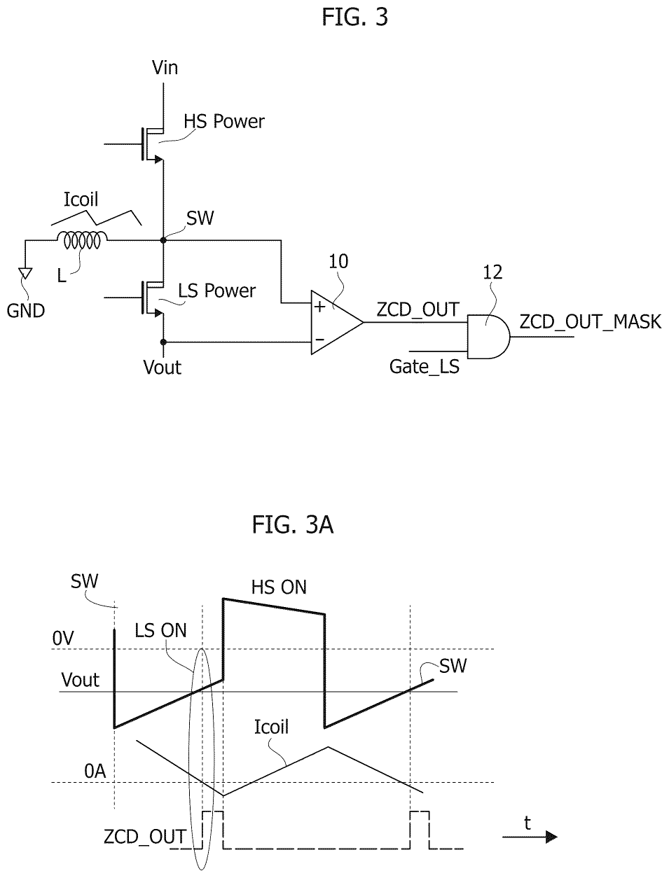

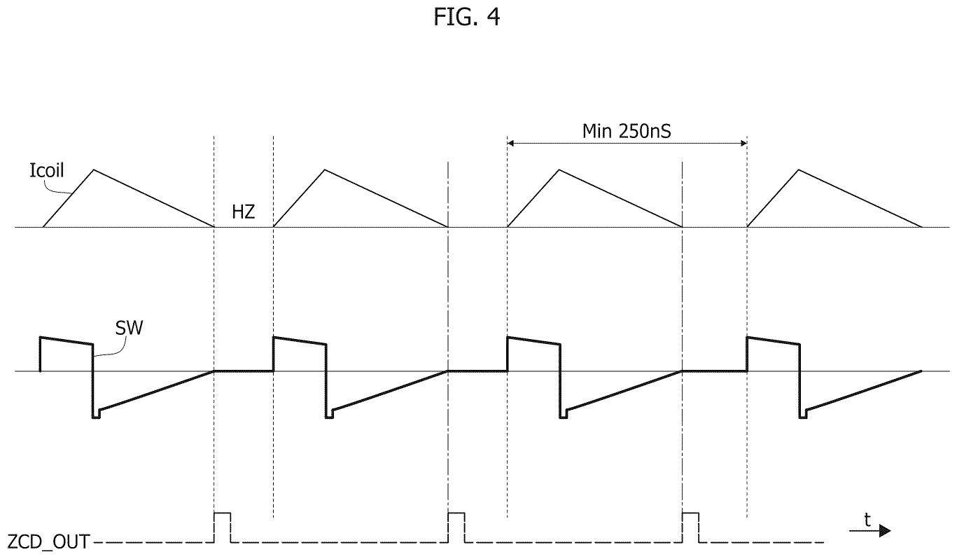

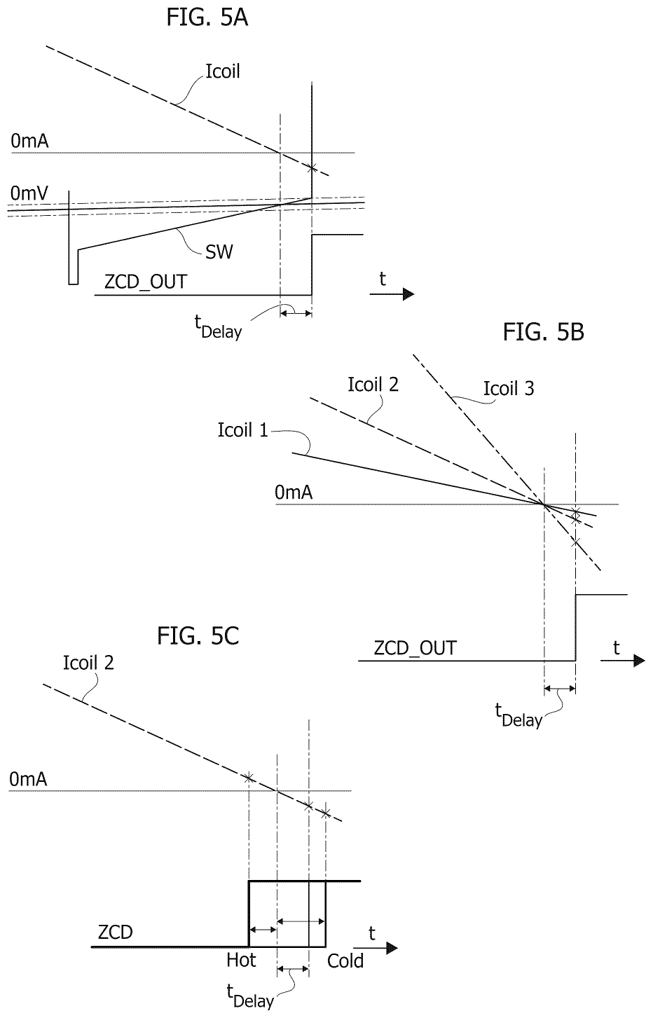

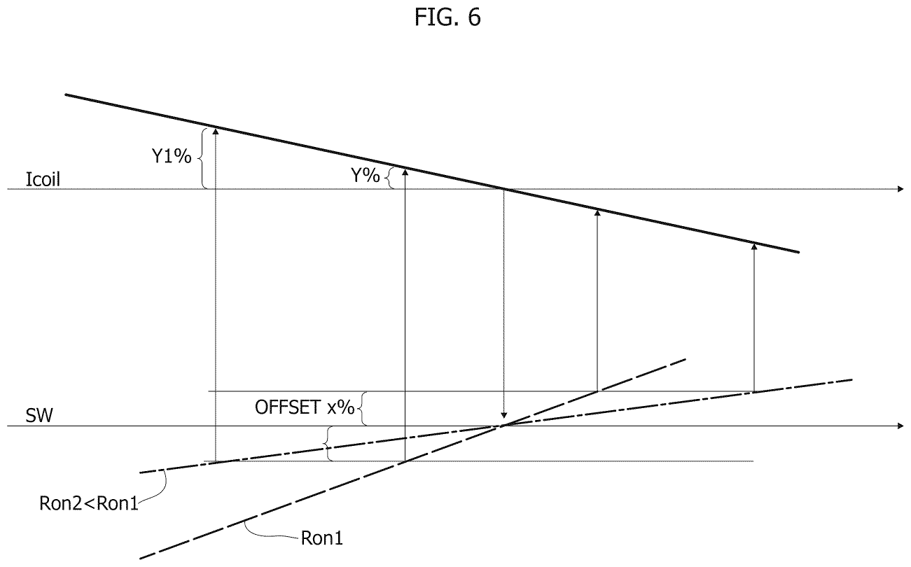

In order to make the present detailed description unduly lengthy and cumbersome, the figures from FIG. 6 onwards will be described by referring in so far as possible to the previous description provided in connection with FIGS. 1 to 5A-5C.

Consequently, in the figures from FIG. 6 onwards, parts, elements and entities already introduced in connection with FIGS. 1 to 5A-5C will be indicated with like designations/references and a detailed description will not be repeated for brevity.

As portrayed in FIG. 6 (and referring, by way of example, to a circuit layout according to a buck configuration as discussed previously), during the conduction phase of the low-side power stage LS, the current through the coil L, namely Icoil can be expressed as: Icoil=Vds/Ron, where Vds and Ron indicate the drain-to-source voltage drop across the low-side power stage (a MOSFET transistor, for instance)—that is the voltage at the node SW—and the “on” resistance thereof.

It is once more stressed that solutions as described herein are intended to facilitate: zero-crossing detection—in a current (Icoil); based on: voltage-based sensing—of a voltage (at the node SW, for instance).

If one assumes having a comparator (see reference 10 in the previous figures) with x% offset: in the presence of a first value Ron1, for the resistance Ron, a Y% uncertainty will result in the coil current Icoil; and in the presence of a second, lower value Ron2<Ron1 for the resistance Ron a (much) greater error Y1% may result in determining the current Icoil.

Therefore, a larger transistor for the power stage LS Power (having a smaller Ron) will involve a more accurate comparator (having less offset). This will result in a (still) larger area and higher complexity, with trimming almost inevitably involved.

The possibility of correcting comparator offset (essentially, the intervention threshold of the comparator) having regard to different use cases and the ability of addressing possible errors due to the latency of the comparator may thus represent a point deserving closer investigation.

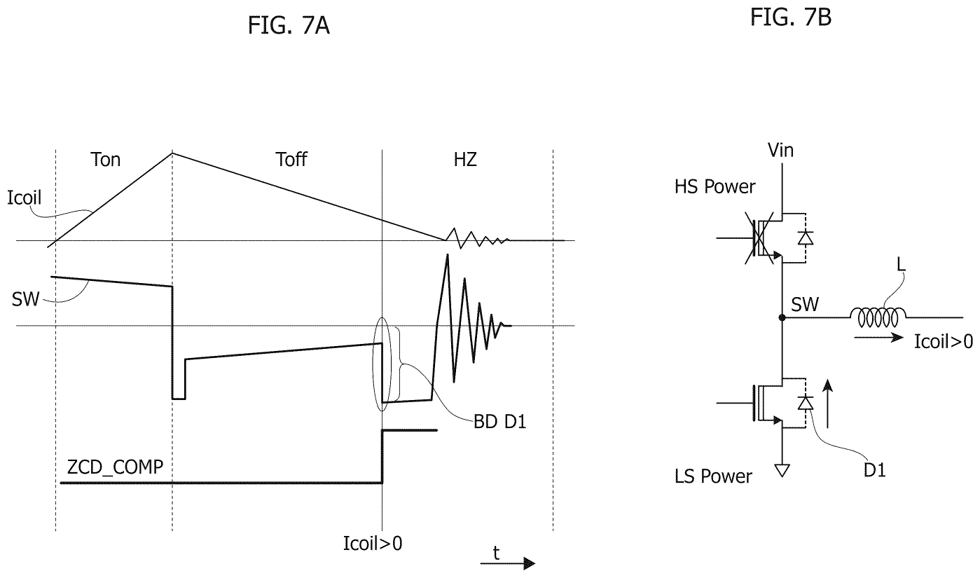

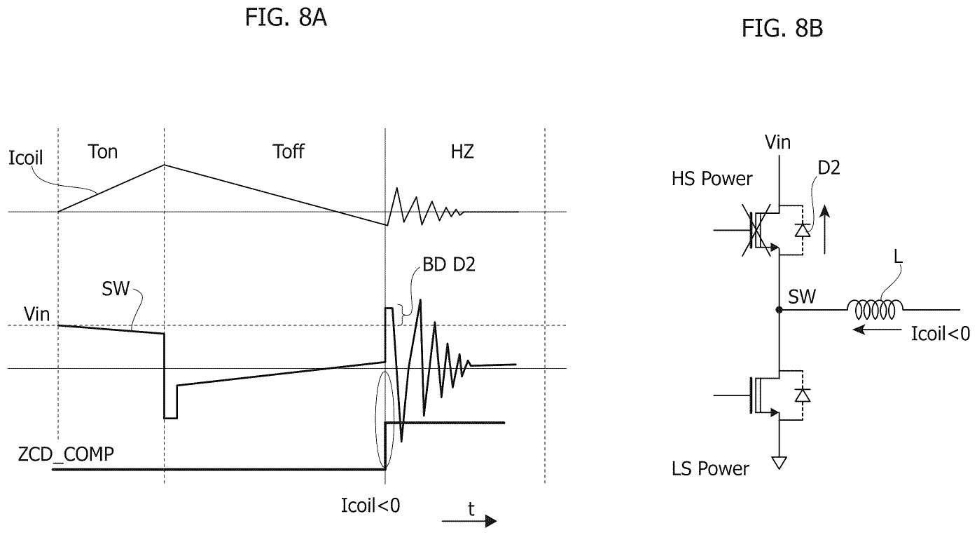

FIGS. 7A, 7B, and 8A, 8B represent possible operation of a ZCD comparator (referring by way of example to a buck configuration) illustrating against a common time (abscissa) scale t possible time behaviors (waveforms) of (from top to bottom): the current through the coil, Icoil; the voltage at the node SW; and the output signal ZCD_COMP from the comparator.

It is noted that a buck configuration is mostly referred to throughout this description for simplicity and ease of understanding. The same underlying principles apply also to other types of configurations with circuit arrangements adapted consistently, with such adaptations falling with the ability of the person skilled in the art.

FIGS. 7A, 7B, and 8A, 8B show the effect of the ZCD comparator output signal ZCD_COMP being switched to “1” to turn off the transistor for the low-side power stage LS Power in conditions where: the current Icoil has a first sign or direction (positive—Icoil>0)—FIGS. 7A and 7B; or the current Icoil has a second sign or direction (negative—Icoil<0)—FIGS. 8A and 8B.

Specifically, FIGS. 7A and 8A show possible time behaviors of the (forward bias) voltage applied to: the body diode D1 of the low-side MOSFET in the low-side power stage LS Power; and to the body diode D2 of the high-side MOSFET in the transistor of the high-side power stage HS Power.

FIGS. 7A, 7B, and 8A, 8B show a time delay between the time ZCD comparator commands LS turn off (the transistor of the low-side power stage LS Power made non-conductive) and the time where the associated bridge actually operates (with the body diodes D1 or D2 turning on, that is becoming conductive). The zero-crossing monitoring window will include this delay.

FIGS. 9A and 9B are exemplary of an approach where the signal SW (essentially the voltage Vds across the transistor of the low-side power stage LS Power, hereinafter LS) is monitored after the ZCD comparator has turned off the LS Power transistor by making it non-conductive.

This can be done, for instance (and in a manner known per se to those of skill in the art), via a monitoring device such as voltage sampler or via a comparator. The information obtained from this device can be used to correct the offset (essentially the intervention threshold) of the main ZCD comparator.

FIGS. 9A and 9B illustrate against a common time (abscissa) scale possible time behaviors of—from top to bottom: the coil current Icoil; the output signal ZCD_COMP from the ZCD comparator; and the signal SW, namely the signal at the node SW.

The diagrams of FIGS. 9A and 9B can be regarded as including the time sequence of phases or areas I to V, namely: I—a ZCD comparator operation area (Toff phase); II—a Vds monitoring area; III—a high impedance (HZ) area; IV—an offset correction area (Ton phase); and V—a further ZCD comparator operation area following offset correction.

The effect of offset correction on the signal Icoil is exemplified at the right end of the related curve: in the case of offset correction starting from Icoil>0 (FIG. 9A); and in the case of offset correction starting from Icoil<0 (FIG. 9B).

In fact, in this latter case the Vds monitor information indicating the conduction of the (body) diode is waited for in order to be then able to “dribble” with the previous state.

An approach as considered herein will thus benefit from: a ZCD comparator that per se will not be required to be highly accurate in so far as the related offset will be corrected, which will in turn facilitate a reduced area occupation; circuitry to generate a (variable) offset to apply to the ZCD comparator, with features that facilitate varying the offset in both directions and understanding when the added offset is too high or too low; and logic circuitry configured to determine whether offset correction is desirable or not.

It is once again noted that varying the offset of the comparator as discussed throughout is exemplary and indicative of the action of varying the intervention threshold of the comparator.

In solutions as described herein, an “adapted” generator is implemented that, operating on a cycle-by-cycle, corrects the ZCD comparator threshold based on a feedback signal.

For instance, when the device starts, the comparator may be unbalanced in such a way to anticipate (or delay) the ZCD thresholding action: this unbalanced condition can be selected and changed as needed.

Based on the feedback signal, the ZCD comparator threshold can be adjusted cycle-by-cycle until an “optimum” condition is reached. Such condition can be represented by a coil current Icoil that comes as close as possible to a zero condition (even though not being exactly at zero).

For instance (as further detailed in the following) the comparator offset can be adapted via an up/down counter. At each clock pulse the offset value can be increased or decreased (one count step at time, for instance) under the control of a control logic operating one step at a time.

A desired (optimum) offset or threshold is held to be reached in response to the control logic being in condition where opposite offset adjustments are commanded at subsequent clock pulses, for instance with the comparator offset value being increased (respectively, decreased) at a certain clock pulse followed by the comparator offset value being decreased (respectively, increased) at the following clock pulse.

In that way the system, will “dribble” around the best zero-crossing threshold detected.

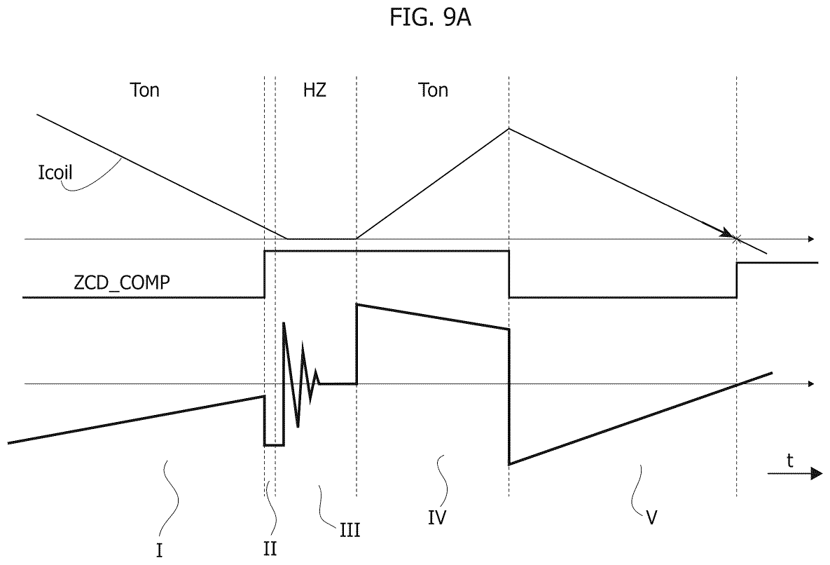

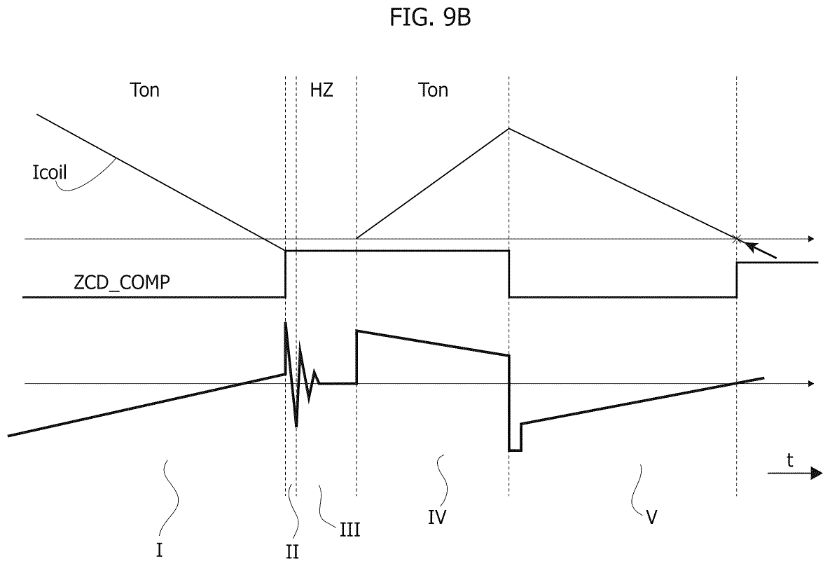

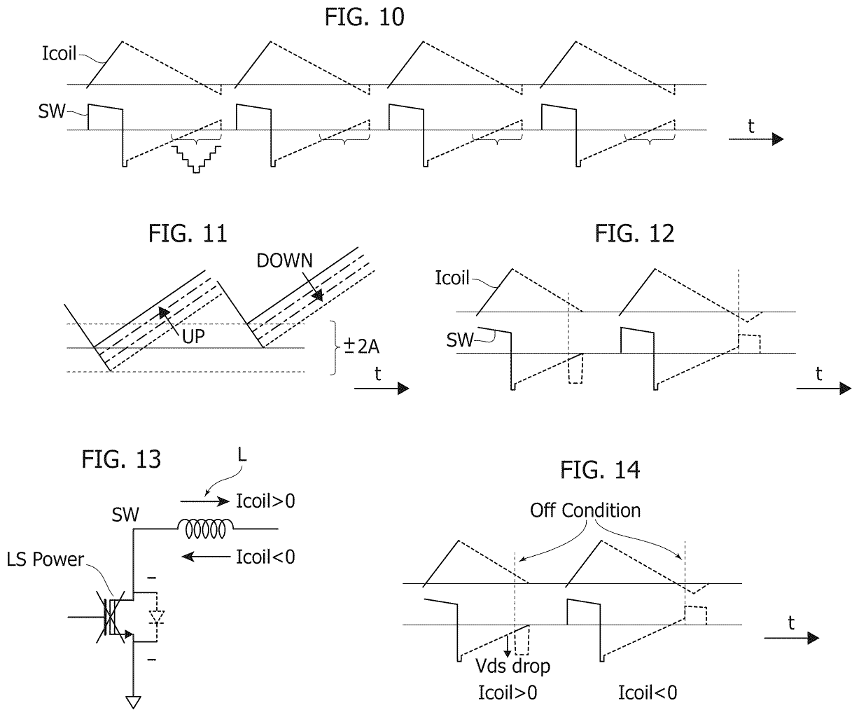

FIGS. 10 and 12 again represent possible time behaviors of the coil current Icoil and the signal SW against a common abscissa time scale t and FIG. 11 exemplifies consequent possible “UP” and “DOWN” offset/threshold correction resulting in behavior as exemplified in FIG. 12.

In a possible implementation of the solution described herein, the drain-to-source voltage drop Vds across the transistor for the low-side power stage LS Power can be sensed (at the node SW, for instance) during the “off” condition in so far as if the behavior the low-side power stage LS Power (namely the SW signal, that is the Vds across the MOSFET transistor in the low-side power stage LS Power) is sensed immediately after the ZCD comparator has turned the stage LS Power off (non-conductive) the possibility exists of determining if, at that instant, the current Icoil circulating in the coil L is still positive (switching on the “low-side” body diode BD D1—see FIGS. 7A and 7B) or negative (switching on the “high-side” body diode BD D2—see FIGS. 8A and 8B).

This is illustrated in FIGS. 13 and 14, showing operation in response to the signal ZCD_COMP=1, with the transistor of the power stage LS Power turned off (made non-conductive) and different time behaviors of the current Icoil at the onset of the “off” condition.

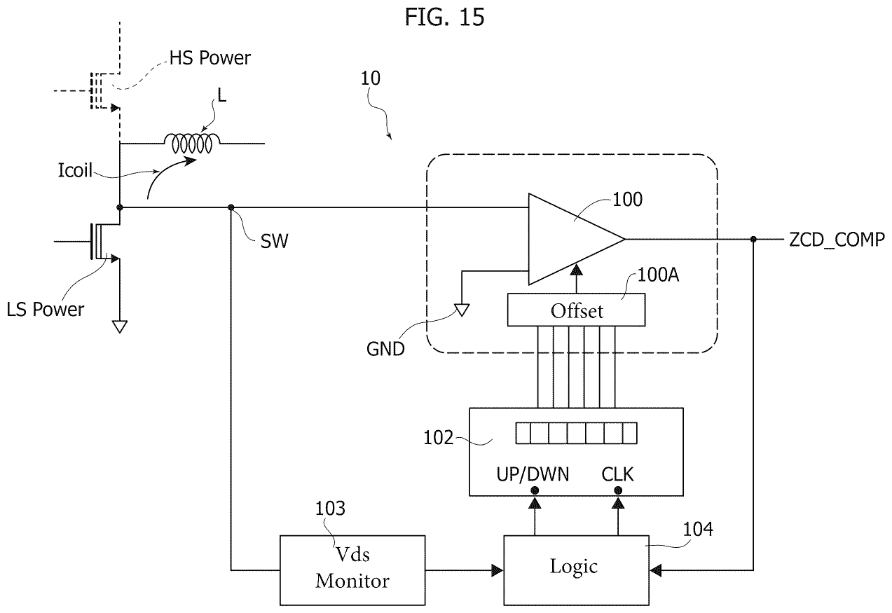

FIG. 15 is a circuit diagram of an embodiment of the present description adapted to applied in the general context discussed at the outset of this description in connection with FIGS. 1 to 5A to 5C (that is without being imperatively limited to a buck configuration as consider herein as an example).

That is, a circuit as exemplified in FIG. 15 can be applied, generally, to a converter comprising: a high-side power stage HS Power and a low-side power stage LS Power having a coil L coupled therebetween at a—current-supply node, wherein the coil is configured to be traversed by a coil current Icoil in response to the transistor of the high-side power stage HS Power and the transistor of the low-side power stage LS Power being turned on and off (not necessarily in a mutually alternate way); a zero-crossing detection (ZCD) circuit 10 configured to issue a ZCD detection signal ZCD_COMP indicative of zero crossing events of the coil-current-Icoil wherein the ZCD circuit 10 comprises: a-voltage-detection node (SW) configured to be coupled to the coil L at the current supply node; and a ZCD comparator having a ZCD input node coupled to the voltage detection node SW and configured to issue a ZCD detection signal in response to the voltage at the voltage detection node SW crossing a selectively tunable ZCD comparator threshold (offset).

In the circuit diagram of FIG. 15, “predictive” ZCD comparator circuitry is illustrated comprising a comparator 100 that should desirably toggle as soon as the current

Icoil in the coil L reaches (in the Toff phase) a zero value for any condition and spread process.

To that effect, the comparator 100 can be configured (in manner known per se) with the ability to adapt its threshold voltage to fit a desired specification having an internal offset tunable via an offset generator 100A.

It is once again noted that varying the offset of the comparator as discussed throughout is exemplary and indicative of the action of varying the intervention threshold of the comparator (this applies even if in FIG. 15 the comparator 100 is illustrated as referred to ground for simplicity).

In the circuit diagram of FIG. 15: reference 102 denotes an up/down (sequential) counter configured to increase or decrease the internal offset of the comparator 100 (de facto, the threshold at which the comparator 100 “trips” or toggles) via the offset generator 100A; reference 103 denotes a Vds monitor level circuitry configured to detect the SW signal, namely the Vds drop across the transistor of the low-side power stage LS Power; and reference 104 denotes logic circuitry configures to manage “adaptive” or adjustable evolution of offset of the comparator 100 according to a desired operation condition.

It is noted that an arrangement as exemplified in FIG. 15 does not merely “move” the problems related to accuracy from the ZCD comparator 100 to the Vds monitor level circuitry 103.

An arrangement as exemplified in FIG. 15 is simple to implement and has a small footprint: the additional area for the logic circuitry 104 and the offset generator 100A are largely outweighed by the possibility of obtaining a system that has a higher accuracy than a single ZCD comparator and is more versatile in respect of possible different applications, with the additional advantage of avoiding trimming.

As noted, high accuracy is not imperative for the ZCD_COMP signal: a comparator 100 with a simple structure can thus be used.

The offset generator 100A is in fact able to recover inaccuracy of the ZCD comparator 100 with a desired granularity (resolution).

Likewise, high accuracy is not imperative for the Vds monitor level circuitry 103.

Advantageous features of this circuitry may involve the ability to be fast enough to “feel” (sense) rapid variations at its input and an adequate sensitivity with respect to the minimum drop that is desired to be detected. In fact, even a relatively inaccurate Vds monitor is able to feel as desired a variation at its input and provide correct sensing over a minimum sensitivity current.

That is, the Vds monitor level circuitry 103 is configured to sense a voltage drop quickly, before the monitoring window closes and before the current has changed sign/direction (that is, it has become negative, with the body diode no longer conductive).

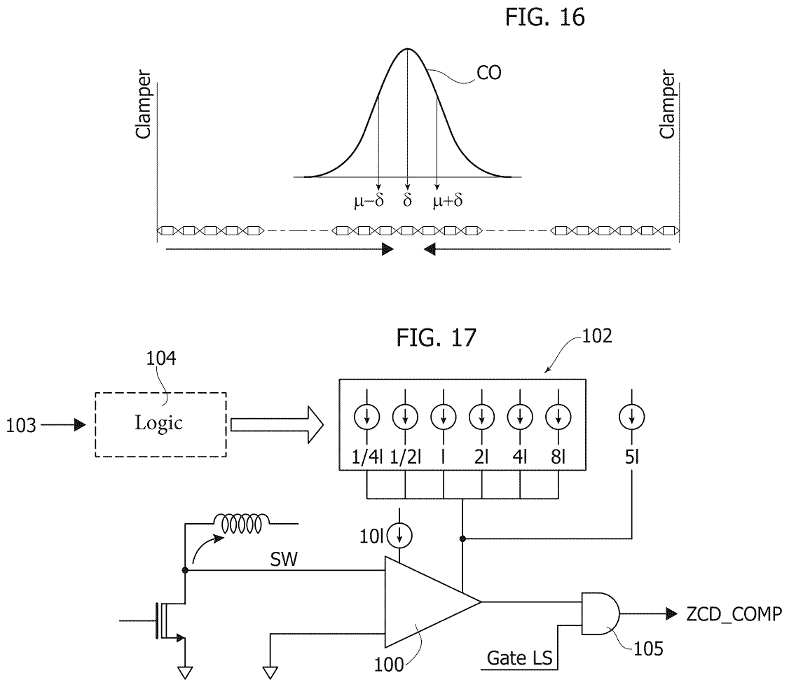

FIG. 16 illustrates the fact that an offset value generated via a digital counter such as the counter 102 has a range (coverage) of comparator offset CO wider than the range applicable to the comparator 100 via the generator 100A. The “remaining” portion of coverage facilitates correcting other phenomena such as latency, adverse effects on Ron, and so on.

Possible options to allow for different functional conditions during start-up may include: starting from a top offset value and decreasing it until a desired threshold is captured; starting from a bottom offset value and increasing until the threshold is captured; or starting from a median offset value and increasing/decreasing it until the threshold is captured.

As noted, at each clock pulse the counter value (and thus the offset/threshold of the comparator 100) can be increased or decreased (one count step at time, for instance).

A desired offset (threshold) can thus be held to be reached in response opposite offset adjustments being generated at subsequent clock pulses, for instance with the comparator offset value increased (respectively, decreased) at a certain clock pulse followed by the comparator offset value decreased (respectively, increased) at the following clock pulse.

Various solutions/implementations of comparators with a tunable offset as known to those of skill in the art can be used in arrangements as discussed herein.

FIG. 17 is exemplary of a possible comparator solution (ZCD comparator 100) having a current offset resolution=¼I so that the ZCD coil current resolution is =(¼I*gmCOMP)/RonLS where: gmCOMP denotes the transconductance of the comparator 100; and RonLS denotes the “on” resistance of the MOSFET transistor in the low-side power stage LS Power.

The comparator 100 is illustrated in FIG. 17 with an associated offset generator 100A driven by a (6-bit, for instance) counter 102 with an AND gate 105 (see the gate 12 in FIGS. 1, 2, and 3) coupled to the output of the comparator 100 to provide an output signal ZCD_COMP gated by a gate signal Gate LS, for instance.

A current digital-to-analog converter DAC can be designed to tune a possible unbalance in a circuit designed to calibrate both positive and negative offset values, with a solution providing a ZCD comparator with a tunable current offset that is both fast and small.

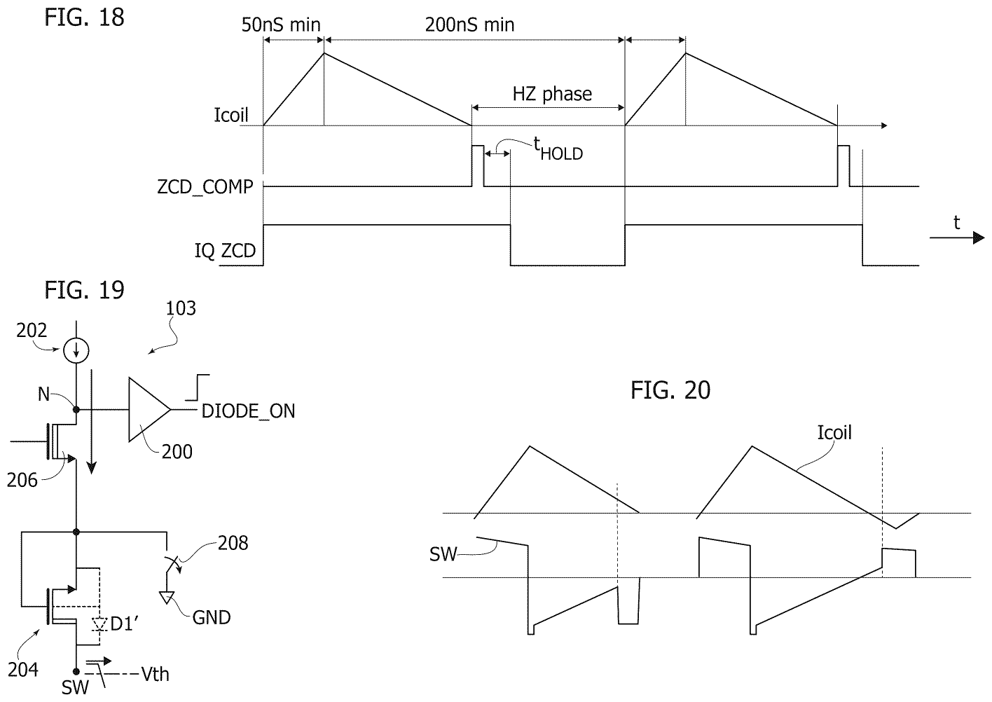

The diagrams in FIG. 18 show (once more against a common time abscissa scale t) possible time waveforms for—from top to bottom: the coil current Icoil; the ZCD comparator output signal ZCD_COMP; and the ZCD comparator quiescent current IQ_ZCD.

The diagram of FIG. 18 shows that, when in discontinuous current mode (DCM) operation with very light loads, the impact of the ZCD comparator quiescent current on the overall efficiency of the converter may be not negligible.

The system can thus be configured so that, when in an ULP (ultra-low power) mode, the ZCD converter can be turned off during a high-impedance phase (HZ phase), leaving just a mirror bias pre-polarization with very low current.

In fact, the ZCD converter can be turned off completely after a time “tHOLD” after the ZCD edge. This time was found to be useful in low-side Vds detection.

Advantageously, the counter 102 of FIG. 15 and FIG. 17 can be a flip-flop-based synchro up-down (UP/DWN) counter.

This can be configured (via an output mux, for instance) to start from a half dynamic state with clampers (top and bottom—see FIG. 16) available to counter undesired cyclic rotation of the count.

Various different solutions can be implemented to measure the voltage Vds (node SW) on the low side.

FIG. 19 details an advantageous solution for low-side Vds detection using a simple current comparator 200 coupled at a node N to a current line from a current generator 202 to a MOSFET transistor 204 to “copy” (that is provide a replica of) the MOSFET transistor in the low-side stage LS Power.

A threshold of the comparator 200 (not to be confused with the comparator 100) is not represented explicitly in so far as switching of the comparator 200 can be determined by the turn-on threshold voltage Vth of the “body-drain” diode D1′ of a MOSFET transistor 204 of the same type (a “replica”) of the MOSFET transistor of the low-side power stage LS Power (thus undergoing the same temperature-induced variations).

As illustrated in FIG. 19, a MOSFET 206 (to be further discussed in the following) can be arranged between the node N and the replica MOSFET 204 to provide a voltage drop Vcas of, for instance, 0.6 V.

The replica sense transistor 204 (here implemented as a MOSFET transistor in the proximity of the MOSFET transistor in the power stage LS Power) can be reasonably expected to exhibit the same temperature\process variation of the threshold voltage of the body diode the MOSFET transistor in the power stage LS Power.

As represented in FIG. 19, when the node SW is at voltage lower than the threshold voltage Vth of the body diode D1 of the replica MOSFET 204 (diode-connected, via source-gate coupling, for instance), the body diode DI therein turns on and the current flowing therethrough is higher than the current from the current generator 202.

The sensitivity of the comparator 200 can be tuned according to the LS body diode characterization, so that the output DIODE_ON from the comparator 200 will toggle giving the desired information. Moreover, a latch can be provided to save the toggle condition.

As soon as the ZCD comparator 100 toggles, the power stage LS Power is turned off (made non-conductive) and the node SW becomes a high impedance node.

This may generate spurious oscillations that may cause the diode comparator 200 to toggle. Thus, the diode comparator can be activated for a short time (less than 20 ns, for instance—see FIG. 20) after the ZCD comparator toggles and shorted to ground GND via a switch 208 (configured to be controlled via a signal Tl as discussed in the following) when not activated.

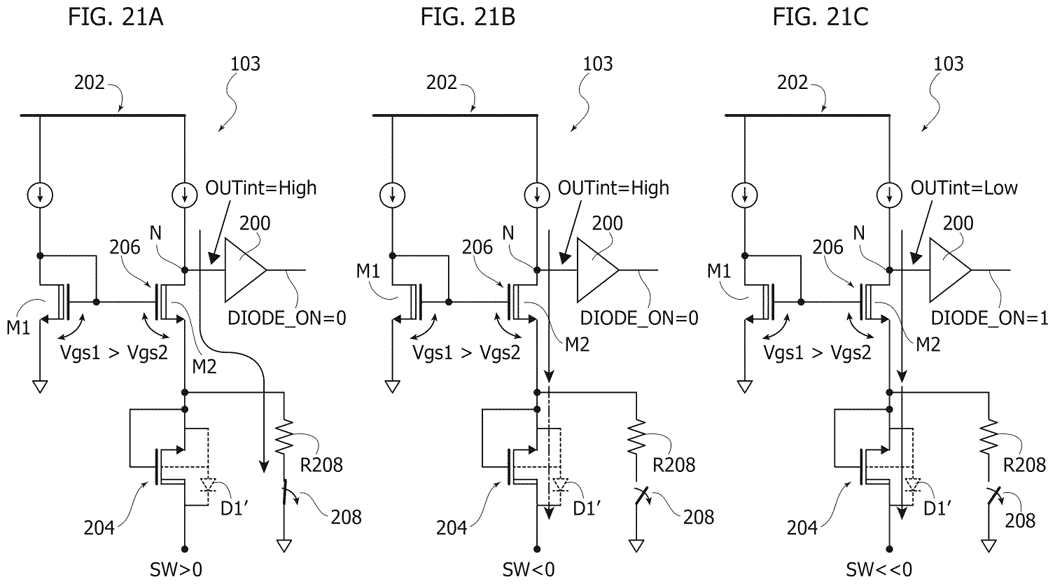

FIGS. 21A, 21B, and 21C provide additional details of the circuit represented in FIG. 19. There the transistor 206 is represented as the transistor M2 in a current mirror arrangement including a mirror transistor M1 configured to be coupled to supply rail Vpre (at 1.8V, for instance) and configured to be traversed by a current that flows through the transistor M1 and is mirrored into the generator 202.

Throughout FIGS. 21A, 21B, and 21C the gate-to-source voltages of the transistors M1 and M2 (reference 206), namely Vgs1 and Vgs2 are held to satisfy the condition Vgs1>Vgs2.

A resistor R208 is also shown in series to the switch 208.

FIGS. 21A, 21B, and 21C refer to low-side Vds detection by considering three possible conditions:

SW>0 (FIG. 21A): This is a Ton phase where the switch 208 (switch T1) is closed and the node N (OUTint) is “high”, with the signal DIODE_ON from the comparator 200 equal to “0” (low).

SW<0 (FIG. 21B): This is a Toff phase where the switch 208 (switch T1) is open and the node N (OUTint) is “high”, with the signal DIODE_ON from the comparator 200 equal to “0” (low).

SW<<0 (FIG. 21C): This is a monitoring phase where the switch 208 (switch T1) is open and the node N (OUTint) is “low”, with the signal DIODE_ON from the comparator 200 equal to “1” (high). If SW>0 (negative coil currents) OUTint remains high.

In the Ton phase of FIG. 21A the bias current is diverted to ground GND through the switch 208 (closed and thus conductive) via the resistor R208 in order to obtain Vgs1>Vgs2; the voltage SW>0 keeps the diode D1 off (non-conductive) and the signal Outint=high.

In the Toff phase of FIG. 21B, SW<0 but this has not (yet) a level enough to make the diode turn on. A small portion of the associated bias current may begin to flow through the diode. The condition Vgs1>Vgs2 results in the signal OUTint=high.

It is noted that: as soon as the Toff phase is entered, the (temporary) switching on of the low-side diode is “masked” by a delayed signal from delay circuitry. In fact, masking is provided at the end of the Ton phase when entering the Toff phase: in that case, temporary diode turn on (with the low-side switch being turned on with a positive current, a small delay avoids undesired high-side and low-side cross-conduction between HS and LS: this of no specific momentum for the purposes herein). Masking is likewise provided at the end of the Toff phase, namely when the diode is monitored: the former masking is used to ignore the beginning of the Toff phase, the latter masking is used for monitoring purposes, at the end of the Toff phase

It is further noted that: the monitoring phase starts as soon as the low-side switch is turned off, which occurs (slightly) after the ZCD comparator trips (due to the time of propagation of the ZCD trip information with the framework of the entire device). If the ZCD comparator does not trip (in the case of high currents) monitoring is started in any case by the information related to low-side turn off, which is synchronous with the PWM signal from the bridge.

A drop in the voltage SW—with the current in the coil still positive—causes switching of the signal DIODE_ON from 0 to 1 (DIODE_ON=1). The signal OUTint is an analog signal that goes from a highest value (Vdd=1.8, for instance) to a low value such as to cause switching of the logical circuitry arranged downstream.

The voltage at the node SW failing to drop or shooting upwardly is indicative of the current having (already) become negative so that the signal SW is not low enough, or even positive so that switching of the signal DIODE_ON from 0 to 1 cannot occur. A slight indetermination around zero exists, which however does not play a significant role.

To summarize, in an implementation as discussed herein: if the coil current is (still) positive, it pulls downwards la OUTint signal, that causes the comparator 200 to trip, namely DIODE_ON=1; and if, conversely, the signal SW does not drop or “shoots” upwards, one has to do with coil currents that are near zero or negative and the OUTint signal remains high.

The switch 208 is left open (non-conductive) throughout the monitoring phase and closed again as soon as it ends.

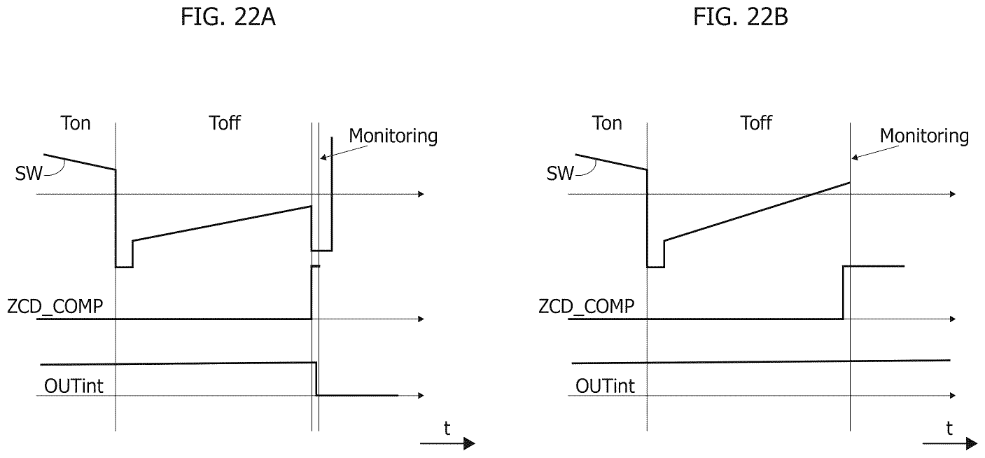

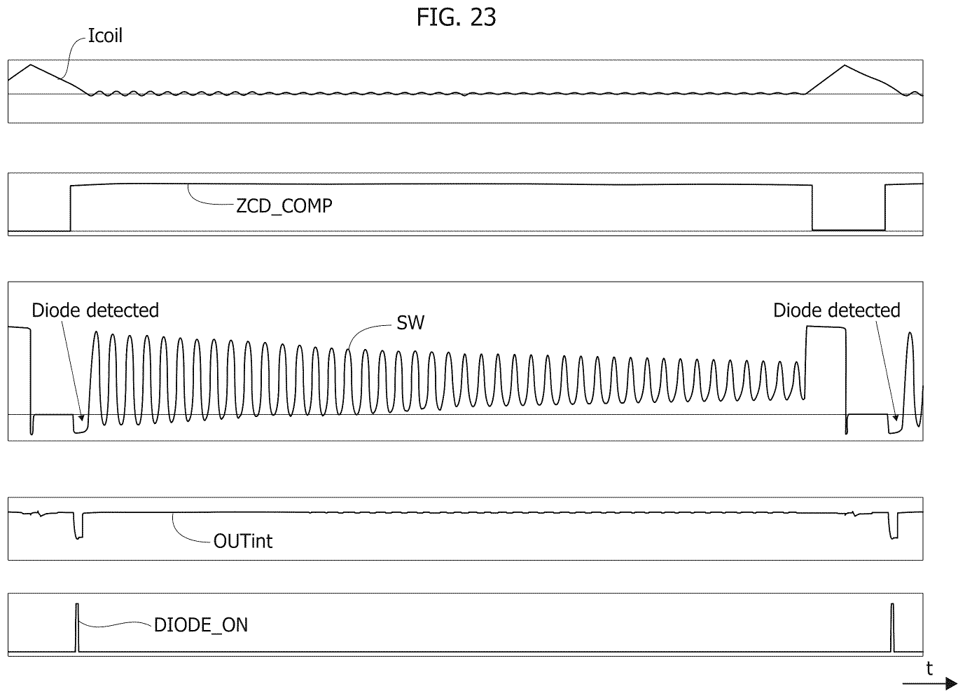

This possible behavior is further exemplified in FIGS. 22A and 22B and in FIG. 23.

These figures show (once more against a common abscissa time scale t) possible waveforms for—from top to bottom in FIGS. 22A and 22B: the voltage at the node SW; the comparator output signal ZCD_Comp; and the signal OUTint into the comparator 200;

These figures also show (once more against a common abscissa time scale t) possible waveforms for—from top to bottom in FIG. 23: the coil current Icoil (Icoil>0); the comparator output signal ZCD_Comp; the diode detection signal at the node SW as affected by spurious oscillations (that may cause the diode comparator 200 to toggle): the signal OUTint into the comparator 200; and the DIODE_ON signal from the comparator 200.

FIGS. 22A and 22B depict the sequence of Ton, Toff and monitoring phases by highlighting that turning on (becoming conductive) of the diode in the transistor of the power stage LS Power in the Toff phase is masked via internal masks.

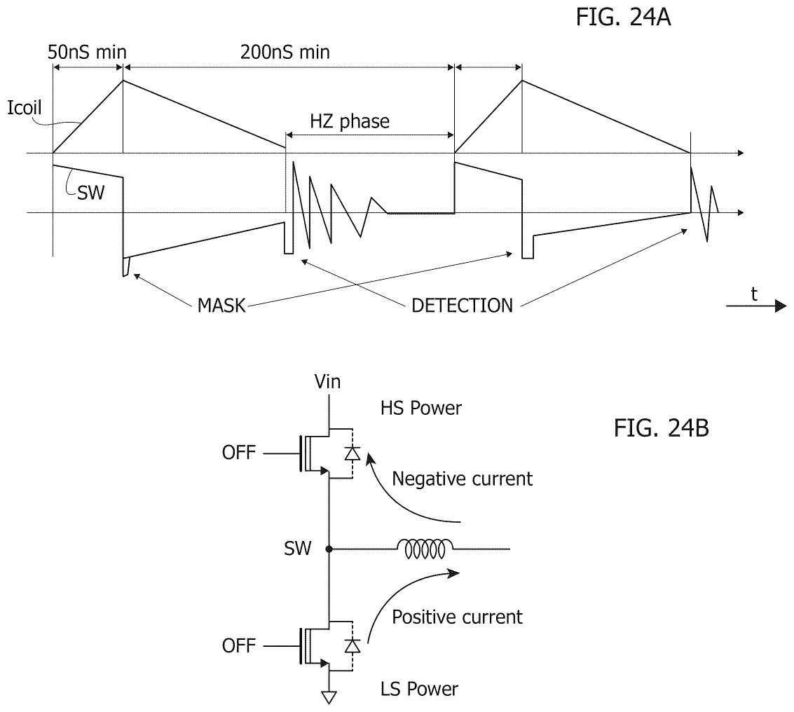

By way of further explanation of ZCD detection in solutions as described herein, FIGS. 24A, and 24B show (as previously, against a common abscissa time scale t) possible waveforms for the coil current Icoil (top) and the voltage at the node SW by highlighting the presence of a high impedance phase HZ as well as masking and detection events.

It is once more recalled that quantitative data presented throughout the figures in support of the description (such as the time durations of 50 nS and 200 nS illustrated in FIG. 24A) are merely exemplary and non-limiting.

FIG. 24B shows possible different signs (directions) of the current Icoil through the coil L, such as, for instance, the current Icoil regarded as “negative” when flowing from the inductor L into the power stage HS Power and “positive” when flowing into the inductor L form the power stage LS Power.

Considering the time behavior of the signals in FIG. 24A, the possibility exists of leaving the circuit active (biased or polarized with output masked) during the Ton phase while altering it (making it operative) and ready to trigger (with its output no longer conditioned) during the Toff phase.

As discussed previously, the dead time introduced at low-side turn on (beginning of the Toff phase) to avoid undesired cross-conduction between high-side and low-side is masked, while the one introduced at low-side turn off (end of the Toff phase) represents the detection phase proper for the diode comparator 200.

Based on the offset of the ZCD comparator, the “zero” (in fact, non-zero) current in the power stage LS Power can be detected as positive or negative.

When the ZCD comparator 100 switches: in the case of a positive coil current Icoil, the diode of the power stage LS Power will be turned on (made conductive) and the voltage at the node SW will drop; and in the case of a negative coil current Icoil, the diode of Power stage HS Power will be turned on (made conductive) and the voltage at the node SW will remain positive (above Vin).

Therefore, the activation of the diode in the power stage LS Power (or the absence of such activation) can be used to check if the ZCD comparator 100 toggles in advance, with a delay or “exactly” (in fact approximately) at the time when coil current Icoil is zero.

This information can thus be used in a circuit layout as represented in FIG. 15 as a feedback signal provided by the Vds monitor block 103 to the logic circuitry 104 to modulate (via the counter 102 and the offset generator 100A, for instance) the offset of the ZCD comparator 100.

It is noted that real time monitoring facilitates taking into account changes in external conditions, including temperature and so on: to that effect offset modulation can be applied in both directions.

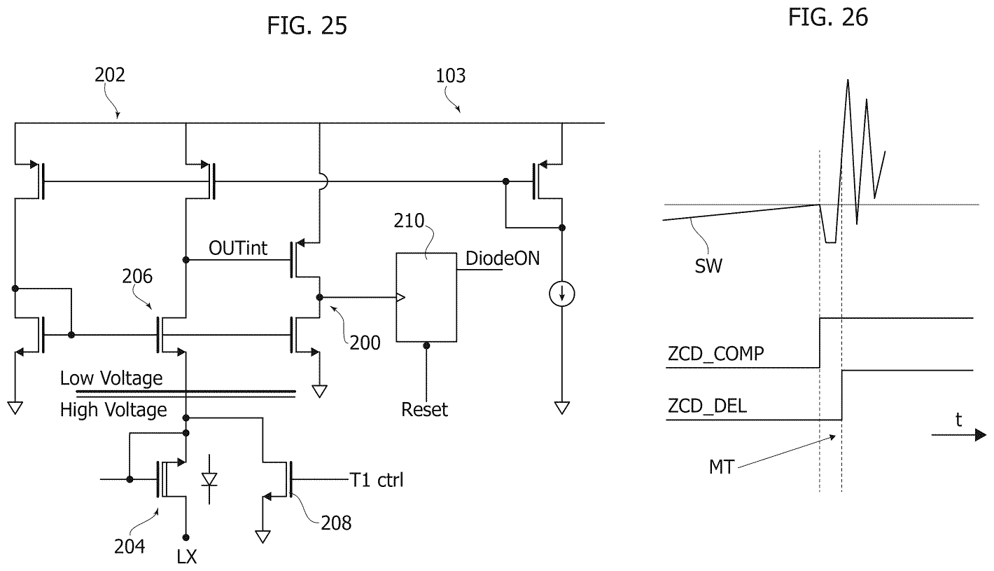

FIGS. 25 and 26 detail a possible implementation of the ZCD diode comparator 200 and associated circuitry, with parts or elements already introduced in connection with FIG. 19 indicated with identical reference symbols.

In FIG. 25 the transistor 208 is shown controllable via a signal T1 ctrl to activate/de-activate the “replica” MOSFET transistor 204. Reference 210 in FIG. 25 indicates an output flip-flop associated with the comparator 200 to produce the signal DIODE_ON.

In FIG. 26 (where the various curves in the diagram share a common abscissa time scale) the top curve represent a possible time behavior of the voltage at the node SW (top curve) plus possible corresponding time behaviors of the signal ZCD_COMP (middle curve) and a delayed version thereof, labeled ZCD_del (bottom curve) delayed of a monitoring time MT.

The signal labeled ZCD_del can in fact be regarded as a “notional” replica of the signal ZCD_COMP having a switching time (raising edge) delayed (a few nanoseconds, for instance) with respect to the switching time (raising edge) of the signal ZCD_COMP.

This is intended to emphasize that the monitoring time MT corresponds to a time window that is synchronized with the turn-off time of the low-side power stage LS Power.

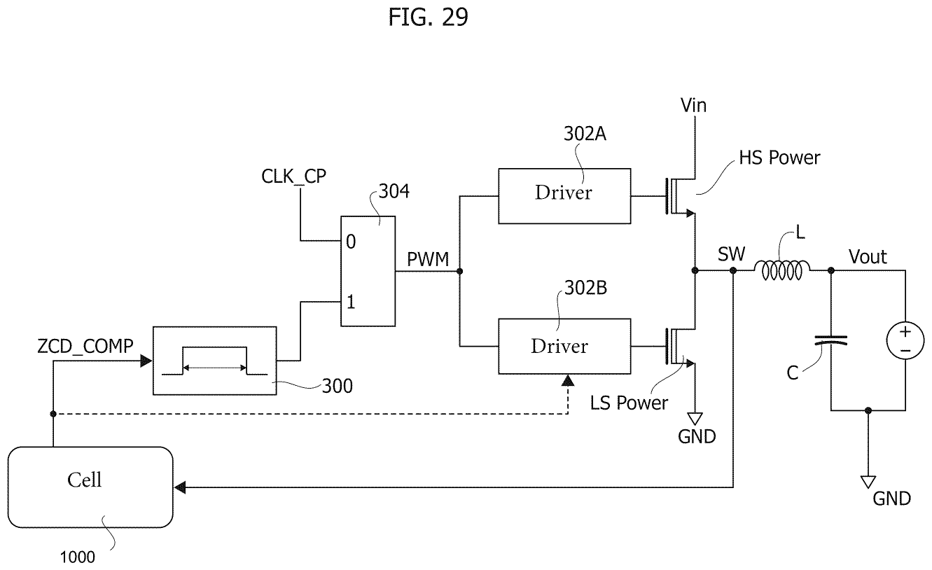

The low-side power stage LS Power can thus be turned off in response to the ZCD comparator 100 toggling (when toggling) or in response to a pulse-width modulated signal (PWM) when the ZCD comparator 100 does not toggle (see the multiplexer circuit 304 described in the following in connection with FIG. 29).

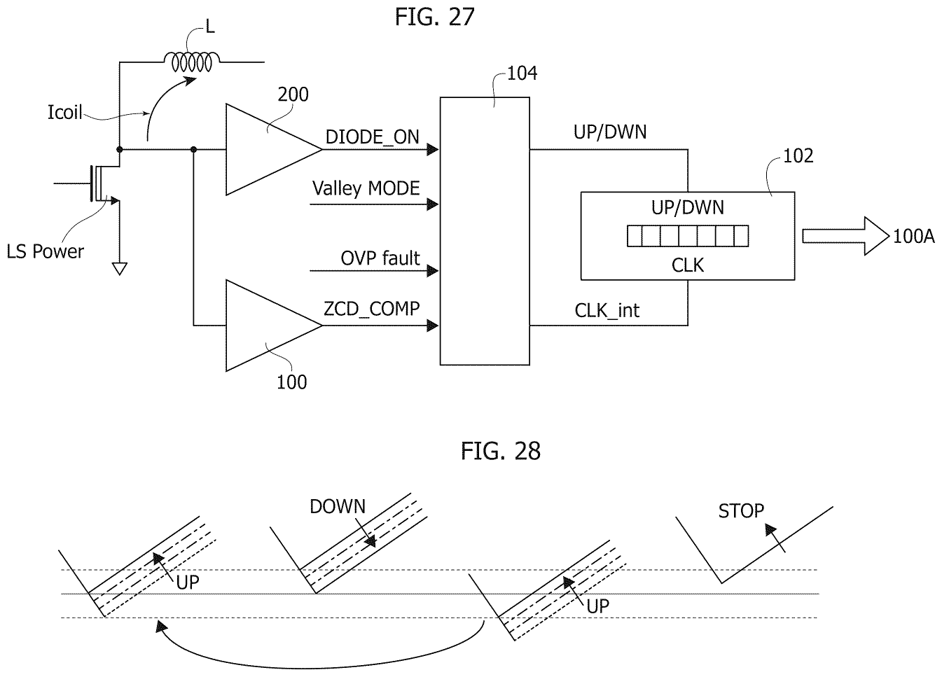

FIG. 27 is a functional block diagram (to be considered in combination with FIGS. 15 and 17) showing possible connections of the ZCD logic control circuitry 104 with the ZCD comparator 100 providing the signal ZCD_Comp (to be delayed as discussed previously during monitoring) and the diode comparator 200 (in the Vds monitor level block 103).

As illustrated in FIG. 27, the logic circuitry 104 can be configured (in a manner known per se to those of skill in the art) to produce an up/down signal and a clock signal CLK_int to drive the counter 102 that varies (via the offset generator 100A) the offset of the ZCD comparator 100 based on the DIODE_ON signal from the diode comparator 200 taking into account the ZCD_COMP signal.

As illustrated in FIG. 27, in order to avoid undesired loss of calibration during detection of Valley MODE (highest peak current in the coil) and OVP (OverVoltage Protection on Vout) operating conditions, adequate signals are processed by combinatory logic thus blocking the CLK_int signal and preventing counter changes.

Advantageously the logic circuitry 104 can be configured to implement an adaptive evolution of the ZCD comparator offset as a function of the operating conditions according to the following Table I showing “Adaptive evolution of the ZCD comparator offset”:

| ZCD_Comp | DIODE_ON | CLK_int | UP_DOWN |
|---|---|---|---|
| 0 | 0 | RUN | 1 |
| 0 | 1 | STOP | DON'T CARE |
| 1 | 0 | RUN | 1 |
| 1 | 1 | RUN | 0 |

The first line in the table refers to a condition where the “native” offset of the ZCD comparator 100 is so negative that no tripping may occur (at least over the whole Toff phase). In the meantime, the coil current has turned into negative e thus the diode comparator 200 is unable to provide any useful information: this is the third time behavior (from left) illustrated in FIG. 28.

The second line in the table refers to continuous current mode (CCM), where the ZCD comparator 100 does not trip in so far as the coil current is positive (DIODE_ON=0) and far from the zero condition. When such a condition is detected, the signal CLK_int is stopped, and the latest calibrated offset is stored to prevent undesired calibration loss of the counter. This is the last, rightmost time behavior illustrated in FIG. 28.

The third line in the table refers to a condition where zero cross detection would correspond to a negative coil current. Offset is increased: this is the first, leftmost time behavior illustrated in FIG. 28.

The fourth line in the table refers to a condition where zero cross detection would correspond to a positive coil current. Offset is reduced: this is the second time behavior (from left) illustrated in FIG. 28.

The horizontal solid line in FIG. 28 represents the ideal zero line of the coil current (Icoil=0).

The first line in the table (third case from the left in FIG. 28) identifies the condition in where the ZCD comparator 100 does not toggle (for some reasons it has a very high, negative offset for instance).

Therefore, switching off of the low-side power stage LS Power (and the consequent start of the Ton phase) is in response to a pulse-width modulated signal (PWM) described in the following in connection with FIG. 29) when the current I coil is already negative: as exemplified herein the system can be configured as a synchronous system where the ZCD comparator 100 is configured (only) to anticipate possible switching off of the low-side power stage LS Power before this is commanded by a subsequent edge of a PWM signal.

In that case (the ZCD comparator being more unbalanced than in the case of a negative coil current means that the “natural” offset is higher than the negative peak of the current ripple), the diode comparator 200 does not toggle (negative current) and the ZCD comparator 100 likewise does not toggle (having quite a negative natural offset). In these conditions, the system will try to change the comparator offset (that is, the comparator threshold) aiming at having the comparator 100 trigger or toggle before a subsequent edge of a PWM signal turns off the low-side power stage LS Power, namely aiming at having the comparator 100 trigger or toggle for negative currents closer to zero.

A situation will thus set on where the ZCD comparator will begin to trigger or toggle reaching the condition in the third line in the table (the first, leftmost time behavior illustrated in FIG. 28). Provided the counter 102 has still “words available”, it will cause the comparator 100 to trigger or toggle earlier than the Icoil current zero-crossing until it gets as close as possible to the optimal threshold (this “ideal” condition is portrayed in the second line in table and in the rightmost time behavior illustrated in FIG. 28).

As discussed previously, the offset (threshold) correction action performed at each pulse of the clock signal CLK_int with cause the ZCD comparator 100 to trigger or toggle reaching the condition in the fourth line in the table (the second time behavior from the left in FIG. 28), thus cause the comparator 100 to trigger or toggle later than the Icoil current zero-crossing.

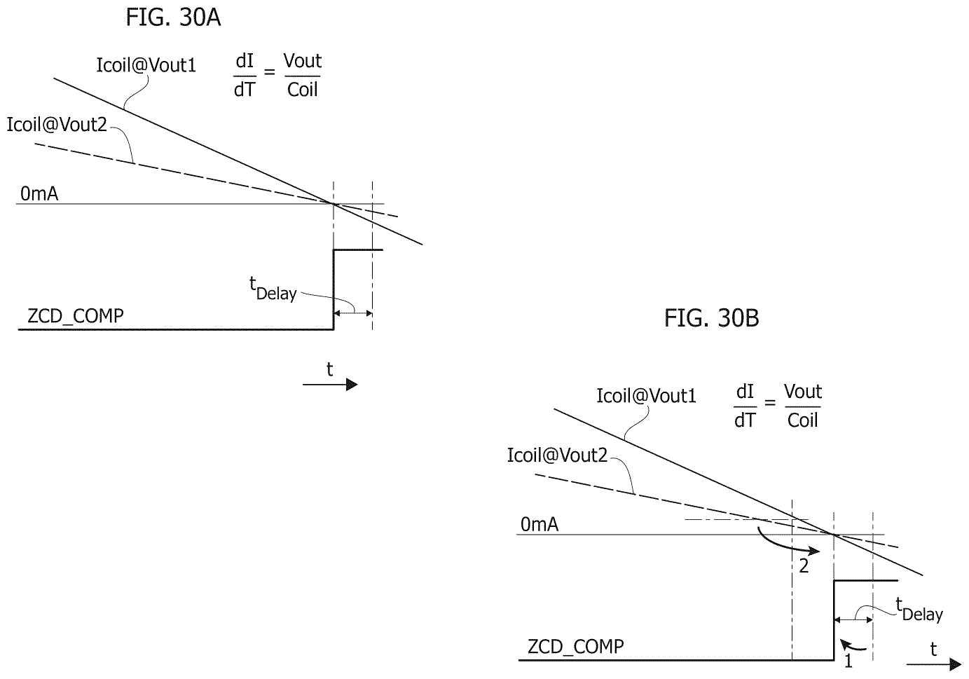

FIG. 29 is a block diagram of exemplary circuitry configured to test a self-calibration loop, with a block 1000 hosting the calibration procedure with associated circuitry to provide a test bench which facilitates testing circuit behavior in line with FIGS. 30A, 30B, 31, and 32A, 32B.

It is noted that the block 1000 in FIG. 29 represents the entire system comprising the ZCD comparator, the diode comparator, and the offset generator having an UP/DWN counter annexed therewith.

In FIG. 29, a load driven via the coil L is represented by a capacitor C referred to ground GND having a voltage Vout applied via the coil L.

In operation of the arrangement illustrated in FIG. 29, in response to the cell 1000 providing a signal ZCD_COMP with a “high” value, this is used to start a new Ton phase with constant duration (given by an astable block 300) and the enter a Toff phase while waiting for self-calibrating ZCD circuit trips at a subsequent new calibrated threshold.

During an initial simulation phase a multiplexer 304 loads a current through the coil. For instance, the multiplexer 304 is configured to apply to the drivers 302A and 302B a pulse-width modulated signal PWM derived for a clock signal CLK_CP (generated in a manner known per se to those of skill in the art, also to facilitated coil pre-charge) received at an input of the multiplexer 304 labeled 0.

After a time (to have a coil current increase up to 10A, for instance), the multiplexer 304 is switched to the input labeled 1 and the loop starts proper operation aiming at achieving a calibrated threshold, with system control being handed over to the ZCD comparator 100 as discussed previously.

As illustrated in FIG. 29, the control terminals (gates in the case of field-effect transistors such as MOSFET transistors) in the power stage HS Power and the power stage LS Power are driven via respective drivers 302A and 302B with the multiplexer 304 can be arranged between the oscillator 300 and the drivers 302A, 302B.

In FIG. 29, a dashed line between the block 1000 and the low-side driver 302B is illustrative of low-side turnoff, followed (immediately) by a high impedance (HZ) phase. After a short delay (duration of the HZ phase) the signal PWM_COMP gives rise to the Ton portion of the PWM signal. It is noted that this delay is not to be confused with masking during monitoring as discussed previously: as noted, the block 1000 in FIG. 29 represents the entire system comprising the ZCD comparator, the diode comparator, and the offset generator having an UP/DWN counter annexed therewith.

FIGS. 30A, 30B, 31, 32A and 32B show that the calibration procedure described herein leads to expected behavior as presented in FIGS. 30A, 30B, 31, 32A and 32B.

FIGS. 30A and 30B compare possible operation of a ZCD comparator affected by a delay t_{Delay} in the case of no calibration (no offset tuning) and in the case of offset tuning applied as disclosed herein.

As discussed in the introductory portion of this description, in the absence of calibration a decrease in Vout results in a decrease of the slope of Icoil during Toff based on the relationship dI/dT=V_{OUT}/Coil.

Two possible time behaviors of Icoil (labeled Icoil@Vout1—dashed line—and Icoil@Vout2—continuous line) result in ZCD detection errors as depicted at the rightmost end of FIG. 30A.

FIGS. 30A and 30B facilitate understanding that, for a same latency of the ZCD comparator, this gives rise to two different current thresholds for two different values of Vout: this is visible at the rightmost end of the figures.

In the case of calibration with Vout1, the circuit will add and offset in such a way to anticipate comparator tripping (that is causing the ZCD comparator to trigger earlier—see the arrow labeled 1) and provide the related information after a latency time such that, at that point, the current will be at (very close to) zero.

If the output voltage changes from Vout1 to Vout2 the same offset will no longer be adequate and the circuit will correct the offset in such a way to provide the related information after a latency time such that, at that point, the current will be again at (very close to) zero, having compensated comparator latency with a lower slope.

In both instances, negative effects are countered with zero-crossing being detected at a zero value for both Icoil@Vout1 and Icoil@Vout2, irrespective of the delay t_{delay}.

In various applications it may be advantageous to decrease the size (area) of the power stages when the load is low in order to increase efficiency.

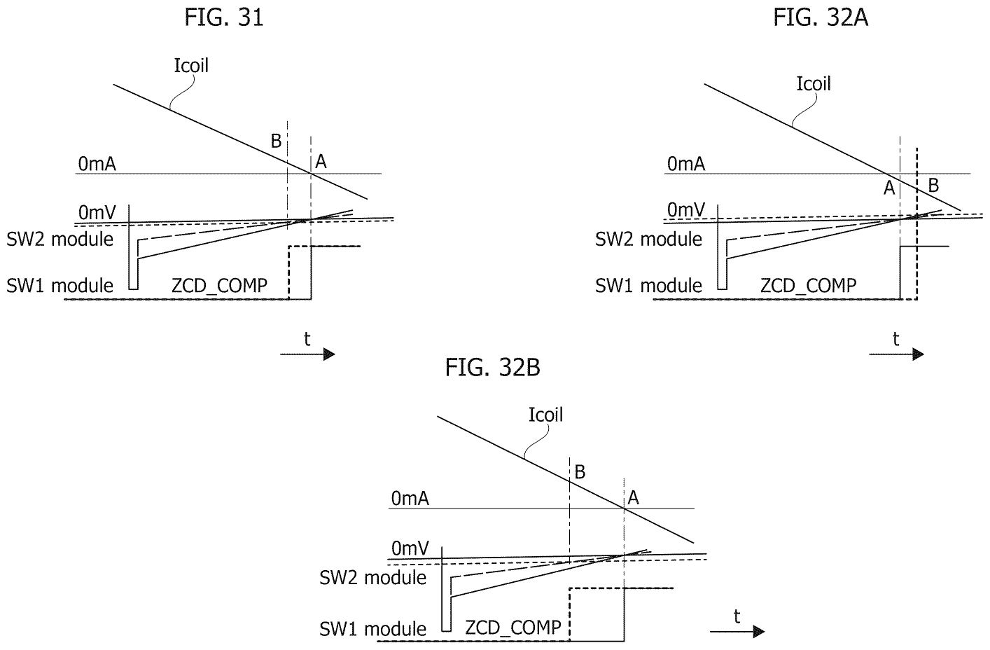

As illustrated in FIG. 31 this may have an impact on ZCD threshold.

In FIG. 31, possible time behaviors are illustrated (against a common abscissa time scale) of—form top to bottom: the current Icoil; two possible outputs from the SW detector circuitry (Vds monitor level) SW_1module—dashed line—and SW_2module—continuous line; and the ZCD_Comp signal.

In the case of a load requiring only one power module, the size (area) of the power stages can be correspondingly decreased so that the ZCD threshold may be located at point A for a small offset of the ZCD comparator 100.

If a larger load is to be taken into account, the size of the power stages is increased to improve efficiency. The device may still be in a discontinuous current mode DCM with the ZCD threshold may be located at a point B, different from point A.

As portrayed in FIG. 32A, in the absence of calibration, when the power stage size changes, the ZCD threshold changes from A to B.

By way of contrast FIG. 32A shows the beneficial effect calibration (offset tuning) in the case of ZCD threshold being increased (step labeled as 1) and in the case of ZCD threshold being decreased (step labeled as 1).

In both instances, negative effects are countered with zero-crossing being detected at a zero value for both Icoil@Vout1 and Icoil@Vout2, irrespective of changes in the load and the power modules.

The effect of a change in the number of modules (in the example considered here, passing from one module to two modules with a resulting reduction of Ron) after achieving a first calibration (see point A) is a renewed correction of the counter word in such a way to bring the new calibration point B (by lowering it) near point A.

In a solution as disclosed herein the logic circuitry 104 can be configured to operate (see also the previous Table I) in such a way the ZCD comparator 100 starts operating while not calibrated and is then calibrated with the counter 102 evolving and ZCD calibration stored in response to transition from continuous current mode to discontinuous current mode (CCM to DCM) operation.

Solutions as described herein provide a zero current detector (ZCD) circuit for a DC-DC converter, for example. While advantageously applicable to buck converters, these solutions can be applied also to boost converters and inverted (“buck-boost”) topologies.

Solutions as described herein adopt a continuous “on-the-fly” offset (threshold) calibration that facilitates optimizing a ZCD threshold (thus system efficiency) primarily in respect of comparator latency, different application cases.

Solutions as described herein avoid a complex structure, mitigating the effect of possible production spread.

Solutions as described herein involve a ZCD threshold that, in steady state, has a small cyclic variation (this a possible effect of cycle-by-cycle calibration). Variations of the input voltage Vin and the output voltage Vout may trigger temporary variations of the ZCD threshold that is corrected within a few clock cycles.

In the exemplary case disclosed herein, adjusting the offset of the comparator 100 involves: increasing the offset (by increasing the comparator threshold) in response to the voltage at the node SW being found to drop as indicative of a negative current Icoil through the coil L at the low-side power stage LS Power turn off; and decreasing the offset (by decreasing the comparator threshold) in response to the voltage at the node SW being found to remain stable or increase as indicative of a nearly zero or positive current Icoil through the coil L at the low-side power stage LS Power turn off.

Those of skill in the art will easily appreciate that the implementations described and illustrated herein refer to possible signal/component polarities (positive/negative) and relative relationships (higher/lower earlier/later) that are purely exemplary and per se non-binding.

For instance, increasing/decreasing the comparator offset (the comparator threshold) may take place in a complementary manner with respect to the exemplary implementation illustrated herein: just to make one possible example, the offset (threshold) correction actions labeled UP and DOWN in figures such as FIG. 11 and FIG. 28 lend themselves to be implemented with contrary signs, while still aiming at adapting the threshold (offset) of the ZCD comparator 100 to cause the tripping or switching time of the—voltage—comparator 100 to match as closely as possible the actual zero level crossing of the—current—through the coil L (namely Icoil).

Also, in various embodiments, the high-side power stage HS Power and the low-side power stage LS Power may be exchanged and/or have different polarities with the positive and negative directions of the currents as shown in FIG. 24 correspondingly reversed.

Whatever the specific details of implementation of the converter/ZCD detector the various solutions discussed herein contemplate a zero-crossing detection, ZCD circuit 10 that is configured to issue a ZCD detection signal ZCD_COMP indicative of zero crossing events of the coil-current-Icoil through the converter coil L by detecting a voltage (Vds of the low-side power stage LS Power) at a voltage detection node such as the node SW configured to be coupled to the coil L at the current supply node for the coil.

Whatever the specific details of implementation of the converter/ZCD detector the various solutions discussed herein comprise a ZCD comparator 100 having a ZCD input node coupled to the voltage detection node SW and configured to issue the ZCD detection signal ZCD_COMP in response to the—voltage—at the voltage detection node SW crossing a threshold of the ZCD (voltage) comparator that is made selectively tunable “on the fly”, via the block 100A, for instance.

The threshold tuning circuitry 102 of the ZCD comparator 100 is configured to selectively vary the threshold of the ZCD comparator 100: in a first direction (by increasing the threshold, for instance) wherein crossing of the ZCD comparator threshold by the voltage at the voltage detection node SW is delayed in time; this may occur—see for instance FIG. 9A—in response to a feedback signal (for instance the signal UP/DWN in FIG. 15) having a first value (UP, for instance); and in a second direction (by decreasing the threshold, for instance) wherein crossing of the ZCD comparator threshold by the voltage at the voltage detection node SW is advanced in time; this may occur—see for instance FIG. 9b—in response to a feedback signal (for instance the signal UP/DWN in FIG. 15) having a second value (DWN, for instance).

As exemplified in figures such as FIG. 19, FIG. 21A, FIG. 21B, and FIG. 21C voltage detection circuitry 104 can be coupled to the voltage detection node SW to detect the presence (occurrence) at the voltage detection node SW of a voltage transition that is indicative of the ZCD detection signal ZCD_COMP being issued in advance of a zero-crossing event of the coil current Icoil.

This possible behavior is illustrated in FIG. 7A where the voltage transition is represented by turn-on of the body diode BD DI of the low-side MOSFET transistor LS Power, which is indicative of the fact that the ZCD detection signal ZCD_COMP being is issued in advance of a zero-crossing event of the coil current Icoil: as illustrated in FIG. 7A the coil current Icoil is (still) positive at the raising edge of the signal ZCD_COMP.

In this case the feedback signal through the threshold tuning circuitry 102 of the ZCD comparator can be generated with the first value so that the comparator threshold/offset is corrected in such a way that—in response to being delayed in time—at a subsequent clock cycle the signal ZCD_COMP is issued at (or generally closer) to the actual zero crossing point of the current Icoil in the coil L (see the right-hand side of FIG. 9A).

The voltage detection circuitry 104 as exemplified in figures such as FIG. 19, FIG. 21A, FIG. 21B, and FIG. 21C can be likewise coupled to the voltage detection node SW to detect the absence (lack of occurrence) at the voltage detection node SW of the voltage transition that is indicative of the ZCD detection signal ZCD_COMP being issued in advance of a zero-crossing event of the coil current Icoil.

This may be the case of the possible behavior illustrated in FIG. 8A where the voltage transition BD D1 of FIG. 7A is replaced by turn-on of the body diode BD D2 of the high-side MOSFET transistor HS Power, which is indicative of the fact that the ZCD detection signal ZCD_COMP being is delayed with respect to a zero-crossing event of the coil current Icoil: as illustrated in FIG. 8A the coil current Icoil is (already) negative at the raising edge of the signal ZCD_COMP.

In this case, the feedback signal through the threshold tuning circuitry 102 of the ZCD comparator can be generated with the second value so that the comparator threshold/offset is corrected in such a way that—in response to being advanced in time—at a subsequent clock cycle the signal ZCD_COMP is issued at (or generally closer) to the actual zero crossing point of the current Icoil in the coil L (see the right-hand side of FIG. 9B).

In either case, the signal ZCD_COMP is issued at a time more faithfully mirroring the actual zero crossing point of the current Icoil in the coil L.

Various embodiments may represent a stand-alone component intended to be coupled an associated load only by an end user and/or only during use of the converter.

Consequently, the associated load (as illustrated on the right-hand side of FIG. 29) may not represent a part of the embodiments.

Without prejudice to the underlying principles, the details and embodiments may vary, even significantly, with respect to what has been described by way of example only, without departing from the extent of protection.

The claims are an integral part of the technical teaching provided herein in respect of the embodiments.

The extent of protection is determined by the annexed claims.

1. A converter, comprising:
a high-side switching transistor;
a low-side switching transistor coupled to the high-side switching transistor at a switching node;
a coil having a first terminal coupled to the switching node, wherein the coil is configured to be traversed by a coil current in response to turning on and off of the high-side switching transistor and low-side switching transistor;
a current source configured to source a sensing current to a sensing node; and
a circuit configured to monitor voltage drop across the low-side switching transistor comprising:
a first transistor having a drain coupled to the sensing node and a source coupled to an intermediate node;
a second transistor having a source coupled to the intermediate node and a drain coupled to the switching node, where a gate of the second transistor is coupled to the intermediate node;
a switch arranged between the intermediate node and a reference node, wherein when the switch is actuated the sensing current flowing through the first transistor flows to the reference node, and wherein when the switch is deactuated the sensing current flowing through the first transistor flows to the switching node through the second transistor; and
a sensing comparator having an input coupled to the sensing node and configured to generate an output signal having a first logic state in response to a voltage transition at the switching node and having a second logic state in response to an absence of the voltage transition at the switching node.

2. The converter of claim 1, wherein the second transistor is a replica of the low-side switching transistor.

3. The converter of claim 2, wherein the switch is activated when the replica second transistor is activated.

4. The converter of claim 1, further comprising a zero-crossing detection (ZCD) circuit configured to generate a ZCD detection signal indicative of zero crossing events of current flowing through the coil, wherein the output signal of the sensing comparator is input to the ZCD circuit, and wherein a ZCD comparator threshold of the ZCD circuit is selectively tunable in response to the output signal.

5. The converter of claim 4, wherein the ZCD circuit includes threshold tuning circuitry configured to selectively vary the ZCD comparator threshold in a zero-crossing detection by the first direction in response to the first logic state of the output signal and selectively vary the ZCD comparator threshold in a second direction in response to the second logic state of the output signal.

6. The converter of claim 5, wherein the first direction delays in time the zero-crossing detection by the ZCD circuit and wherein the second direction advances in time the zero-crossing detection by the ZCD circuit.

7. The converter of claim 5, wherein the first direction advances in time the zero-crossing detection by the ZCD circuit and wherein the second direction delays in time the zero-crossing detection by the ZCD circuit.

8. The converter of claim 5, wherein the threshold tuning circuitry of the ZCD comparator comprises an up/down counter configured to increase and decrease the ZCD comparator threshold in response to the first and second logic states of said output signal.

9. The converter of claim 1, wherein the switch is activated when the second transistor is activated.

10. The converter of claim 1, wherein the circuit configured to monitor voltage drop further comprises:
a further current source configured to supply current to a further intermediate node; and
a third transistor having a drain and gate coupled to the further intermediate node and a source coupled to the reference node.

11. A device, comprising:
the converter of claim 1; and
an electrical load coupled to said coil.
